(19) United States
(12) Patent Application Publication
(10) Pub. No.: US 2022/0004920 A1
(43) Pub. Date: Jan. 6, 2022

(54) CLASSIFICATION DEVICE, CLASSIFICATION METHOD, AND CLASSIFICATION PROGRAM

(71) Applicant: NIPPON TELEGRAPH AND TELEPHONE CORPORATION, Tokyo (JP)

(72) Inventors: Taishi NISHIYAMA, Musashino-shi, Tokyo (JP); Atsutoshi KUMAGAI, Musashino-shi, Tokyo (JP); Kazunori KAMIYA, Musashino-shi, Tokyo (JP)

(73) Assignee: NIPPON TELEGRAPH AND TELEPHONE CORPORATION, Tokyo (JP)

(21) Appl. No.: 17/280,184

(22) PCT Filed: Oct. 10, 2019
(86) PCT No.: PCT/JP2019/040108

§ 371 Date: Mar. 26, 2021

(30) Foreign Application Priority Data
Oct. 31, 2018 (JP) 2018-205795

(51) Int. Cl. G06N 20/00

(52) U.S. Cl. CPC G06N 20/00

(57) ABSTRACT

A score calculation unit (15c) calculates, based on the feature value of data and a weight, the score of the data using a score function. An optimization unit (15d) approximates, with respect to an AUC of a partial area of a ROC curve for a classifier that classifies the data into a positive instance or a negative instance based on the calculated score, a nonlinear function portion of an object function using a predetermined method, the object function being represented by approximation of the AUC of the partial area, and learns the weight so that the approximated object function is maximized.

### TECHNICAL FIELD

The present invention relates to a classification apparatus, a classification method, and a classification program.

### BACKGROUND ART

In machine learning, the simplest task is binary classification of instances into two classes, such as a task of determining whether an e-mail is a spam e-mail or a ham e-mail, or a task of determining whether a patient has cancer or not. In binary classification, there are often cases where the numbers of pieces of data are imbalanced between the classes, such as when test results of ninety-nine healthy persons and one cancer patient are classified. Conventionally, “Area Under the Curve (AUC)” is known as an index for the properties of a classifier in a binary classification problem generated using machine learning.

Here, in the binary classification problem of classifying the feature value of classification target data into positive and negative instances, the property of the classifier is defined using “True Positive (TP)”, “False Positive (FP)”, “False Negative (FN)”, and “True Negative (TN)”. “True Positive” means that a positive instance is correctly classified as positive, and “False Positive” means that a negative instance is mistakenly classified as positive. Also, “False Negative” means that a positive instance is mistakenly classified as negative, and “True Negative” means that a negative instance is correctly classified as negative.

In this case, the detection rate of the classifier is denoted as “True Positive Rate (TPR)”, that is, TP/(TP+FN). Also, the false detection rate of the classifier is denoted as “False Positive Rate (FPR)”, that is, FP/(FP+TN).

Also, a Receiver Operating Characteristic (ROC) curve is a curve obtained by calculating TPRs and FPRs for thresholds of the feature value scores by means of which a piece of data is determined to be a positive instance or a negative instance, two-dimensionally plotting the TPRs for the thresholds on the vertical axis and the FPRs on the horizontal axis, and connecting the plurality of points to each other. Also, the AUC refers to the area of a portion enclosed by the ROC curve and the coordinate axes. The AUC is an index that takes a value between 0 and 1, and indicates the higher classification property the closer it is to 1.

The AUC is thus a value that takes into consideration whether it is true or false for both of the positive and negative instances. Therefore, in the binary classification problem in which imbalanced amount of data of positive and negative instances, such as test results of ninety-nine healthy persons and one cancer patient, are classified, the AUC is effective as an index for the classification property, compared to the accuracy calculated as 99% when all of the persons are classified into healthy persons, for example.

On the other hand, in practical tasks, there may be a case where the detection rate (TPR) in a region in which the false detection rate (FPR) is low (close to 0) is regarded as important. For example, in a case where it is determined whether or not a patient has cancer, if the false detection rate is high, a large number of healthy persons will be mistakenly determined as having cancer. Accordingly, practically, it is preferable to optimize the detection rate while suppressing the false detection rate. In contrast, there is a case where the AUCs are equal to each other, but the detection rates in the low false detection rate regions are different from each other. Accordingly, a technique for optimizing a portion of the AUC (hereinafter, referred to as “pAUC (partial AUC) optimization problem”) has been under review (see PTL 1 and PTL 2, and NPL 1)

### CITATION LIST

### Patent Literature

[PTL 1] Japanese Patent Application Publication No. 2017-102540
[PTL 2] Japanese Patent Application Publication No. 2017-126158

### Non Patent Literature

[NPL 1] Harikrishna Narasimhan et al. “A Structural SVM Based Approach for Optimizing Partial AUC”, 2013

### SUMMARY OF THE INVENTION

### Technical Problem

However, the conventional techniques require repeatedly performing optimization processing on a nonlinear portion of a function that indicates pAUC, causing the problem that the calculation cost is high.

The present invention was made in view of the foregoing circumstances, and an object thereof is to optimize a portion of the AUC in the binary classification problem while suppressing the calculation cost.

### Means for Solving the Problem

In order to solve the above-described problems and achieve the object, the classification apparatus according to the present invention includes: a score calculation unit configured to calculate, based on a feature value of data and a weight, a score of the data using a score function; and a learning unit configured to approximate, with respect to an AUC of a partial area of a ROC curve for a classifier that classifies the data into a positive instance or a negative instance based on the calculated score, a nonlinear function portion of an object function using a predetermined method, the object function being represented by approximation of the AUC, and learn the weight so that the approximated object function is maximized.

### Effects of the Invention

According to the present invention, it is possible to optimize a portion of the AUC in the binary classification problem while suppressing the calculation cost.

### BRIEF DESCRIPTION OF DRAWINGS

FIG. 1 is a diagram illustrating an outline of processing performed by a classification apparatus according to an embodiment.

FIG. 2 illustrate an outline of processing performed by the classification apparatus according to the present embodiment.

FIG. 3 is a diagram illustrating an outline of processing performed by the classification apparatus according to the present embodiment.

FIG. 4 is a schematic diagram illustrating an example of a configuration of the classification apparatus in outline.

FIG. 5 is a flowchart illustrating a procedure of learning processing.

FIG. 6 is a flowchart illustrating a procedure of determination processing.

FIG. 7 is a diagram illustrating an example of a computer that executes a classification program.

### DESCRIPTION OF EMBODIMENTS

Hereinafter, an embodiment of the present invention will be described in detail with reference to the drawings. Note that the present invention is not limited to this embodiment. Also, in the description of the drawings, the like reference numerals are given to objects having like names.

[Overview of Classification Apparatus]

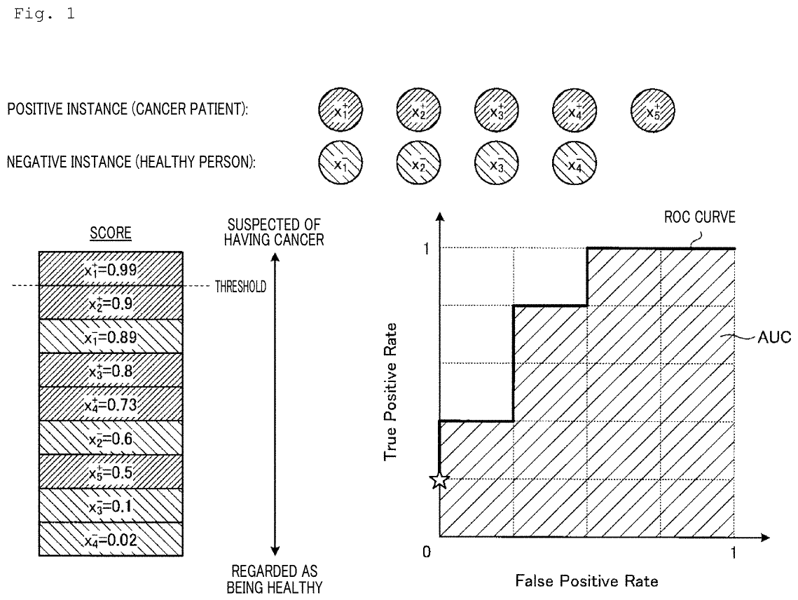

FIGS. 1 to 3 are diagrams illustrating an outline of processing performed by a classification apparatus according to an embodiment. First, FIG. 1 shows an example of a method for drawing a ROC curve when a classifier classifies a cancer patient as a positive instance and a healthy person as a negative instance. In the example shown in FIG. 1, the classifier determines, using a threshold, whether the scores of positive feature values x₁⁺, x₂⁺, x₃⁺, x₄⁺, and x₅⁺, and negative feature values x₁⁻, x₂⁻, x₃⁻, and x₄⁻ correspond to a positive instance or a negative instance. That is to say, if the score of each of the feature values is greater than or equal to the threshold, the classifier determines that the feature value corresponds to a positive instance (cancer patient), and if the score of the feature value is less than the threshold, the classifier determines that the feature value corresponds to a negative instance (healthy person).

For example, if the threshold is set to a value between 0.9 and 0.99, the classifier does not determine any negative instance as positive (cancer patient), and the false detection rate (FPR) is 0%. Also, this classifier correctly determines one instance, out of the five positive instances, as positive, and the detection rate (TPR) is 20%. In this case, as indicated by the star sign shown in a two-dimensional coordinate system in FIG. 1, (FPR, TPR)=(0, 0.2) is plotted.

Classification results vary depending on the threshold. Accordingly, by changing the threshold and repeatedly performing the foregoing processing, a plurality of points are plotted on the two-dimensional plane coordinate system shown in FIG. 1. The curve obtained by connecting the plurality of plotted points to each other corresponds to a ROC curve. Also, the area of a region hatched in FIG. 1 that is enclosed by the ROC curve and the two axes, and is located on the lower side of the ROC curve corresponds to the AUC. In the example shown in FIG. 1, the AUC is calculated as 16/20=0.8.

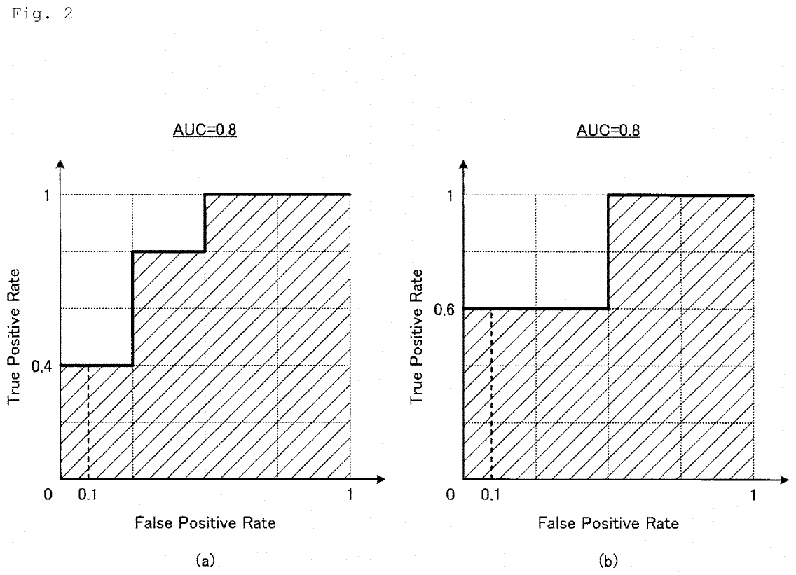

Here, FIG. 2 show examples of cases where the AUCs are equal to each other, but the detection rates in the low false detection rate regions, in which the FPR is close to 0 rather than 1, are different from each other. In the examples shown in FIG. 2, namely, both of FIGS. 2(a) and 2(b), the AUC is 0.8, but TPRs in the regions in which the FPR is low are different. When, for example, the FPR is 0.1, the TPR is 0.4 in FIG. 2(a), and is 0.6 in FIG. 2(b). Accordingly, the classification apparatus of the present embodiment performs optimization of the detection rate in the low false detection rate, that is, optimization of a portion of the AUC.

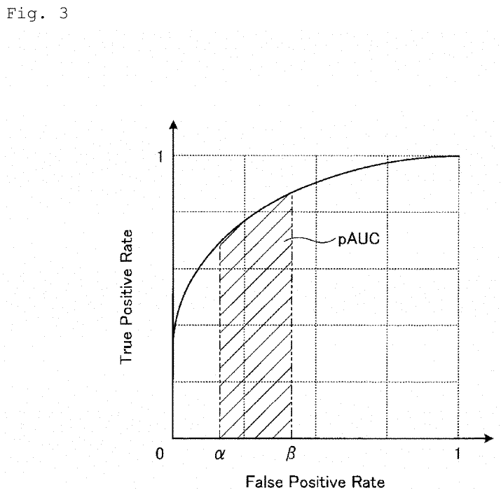

FIG. 3 shows an example of a portion of an AUC that is a processing target of the classification apparatus of the present embodiment. The classification apparatus of the present embodiment generates a classifier that maximizes the AUC of a partial area (which is the area of the hatched region in FIG. 3, and hereinafter is denoted by “pAUC”) in which the FPR of the ROC curve is [α, β] (0≤α<β≤1).

The AUC of the partial area of the ROC curve shown in FIG. 3 is given by Formula (1) below using the feature value x, the score function f, and the Heaviside step function I. Here, m is the number of positive instances, and n is the number of negative instances. Also, “x₁⁺” is the i-th positive feature value, and “xⱼ⁻” is the j-th negative feature value.

$$[ Formula 1 ]$$

$$AUC = \frac{1}{mn} {\sum }_{i = 1}^{m} {\sum }_{j = 1}^{n} I ( f ( {x}_{i}^{+} ) - f ( {x}_{j}^{-} ) ) \qquad ( 1 )$$

Also, the pAUC is given by Formula (2) below. Here, “jₐ” is the smallest integer of nα or greater. Also, “j_{β}” is the largest integer of nβ or less. Also, “x₍ⱼ₎” is the j-th negative feature value sorted in the order of scores.

$$[ Formula 2 ]$$

$$pAUC = \frac{1}{mn ( β - α )} {\sum }_{i = 1}^{m} [ ( {j}_{α} - n α ) \cdot I ( f ( {x}_{i}^{+} ) > f ( {x}_{( {j}_{α} )}^{-} ) ) + {\sum }_{j = {j}_{α} + 1}^{{j}_{β}} I ( f ( {x}_{i}^{+} ) > f ( {x}_{( j )}^{-} ) ) + ( n β - {j}_{β} ) \cdot I ( f ( {x}_{i}^{+} ) > f ( {x}_{( {j}_{β} + 1 )}^{+} ) ) ] \qquad ( 2 )$$

The classification apparatus of the present embodiment performs classification processing, which will be described later, and determine a weight w that maximizes the pAUC given by Formula (2). The classifier calculates the score of data using the score function to which the determined weight w is applied, and determines, using a predetermined threshold, whether the calculated score corresponds to a positive instance or a negative instance.

Note that, as shown in Formula (2) above, in order to maximize the pAUC, optimization processing will be repeated while negative instances are sorted in the order of scores.

[Configuration of Classification Apparatus]

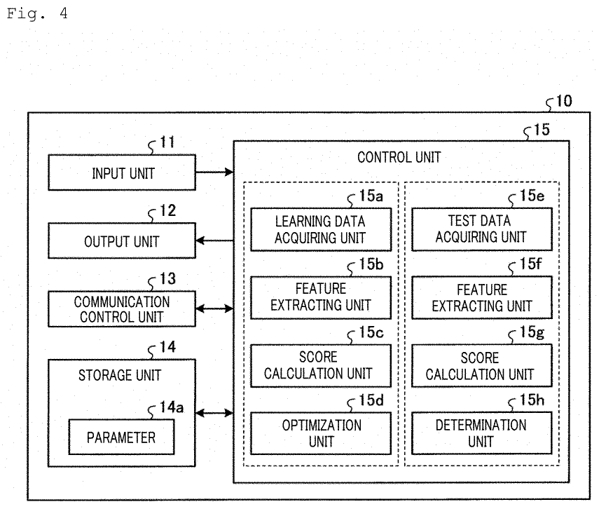

FIG. 4 is a schematic diagram illustrating an example of an overview of a configuration of the classification apparatus. As shown in FIG. 4, a classification apparatus 10 is realized by a general-purpose computer such as a personal computer, and includes an input unit 11, an output unit 12, a communication control unit 13, a storage unit 14, and a control unit 15.

The input unit 11 is realized by an input device such as a keyboard and a mouse, and inputs, to the control unit 15, information on various types of instructions such as an instruction to start processing in response to an input operation made by an operator. The output unit 12 is realized by a display apparatus such as a liquid crystal display, a printing apparatus such as a printer, or the like. The communication control unit 13 is realized by a Network Interface Card (NIC) or the like, and controls communication between the control unit 15 and an external apparatus such as a network apparatus or an administrative server via a telecommunication line such as a Local Area Network (LAN) or the Internet.

The storage unit 14 is realized by a semiconductor memory element such as a Random Access Memory (RAM) or a Flash Memory, or a storage device such as a hard disk or an optical disc, and stores a parameter 14a of a classifier generated in classification processing, which will be described later, or the like. Note that the storage unit 14 may also be configured to communicate with the control unit 15 via the communication control unit 13.

The control unit 15 is realized by a Central Processing Unit (CPU) or the like, and executes a processing program stored in the memory. Accordingly, as exemplified in FIG. 4, the control unit 15 functions as a learning data acquiring unit 15a, a feature extracting unit 15b, a score calculation unit 15c, an optimization unit 15d, a test data acquiring unit 15e, a feature extracting unit 15f, a score calculation unit 15g, and a determination unit 15h.

Note that these functional units or portions thereof may also be implemented in different hardware. For example, the classification apparatus 10 may be divided into a learning apparatus in which the learning data acquiring unit 15a, the feature extracting unit 15b, the score calculation unit 15c, and the optimization unit 15d are implemented, and a determination apparatus in which the test data acquiring unit 15e, the feature extracting unit 15f, the score calculation unit 15g, and the determination unit 15h are implemented.

The learning data acquiring unit 15a acquires learning data for use in the later-described classification processing via the input unit 11 or the communication control unit 13.

The feature extracting unit 15b extracts the feature value of the obtained learning data, as preparation for the learning data to be used for later-described processing of the optimization unit 15d. Here, the feature value refers to a combination of viewpoints of classification target data. Examples of the feature value for use in classification of health or illness include the number of cigarettes one smokes in a single day, the BMI, and the amount of alcohol intake in a single day. Note that the method for extracting the feature value is not particularly limited. A manual method may be applied or a method such as deep learning may also be applied in which features are automatically extracted and machine learning is performed.

Also, the feature extracting unit 15b converts the extracted feature value into a feature vector. For example, the feature extracting unit 15b uses a method such as Bag-of-Words or N-gram to convert the feature value into a feature vector.

The score calculation unit 15c calculates, based on the feature value of the data and a weight, the score of the data using a score function f. Here, when a linier score function is used as the score function f, the score function f is given as Formula (3) below with the weight w and the feature value (feature vector) x.

[Formula 3]

f=w^{T}x (3)

Note that the weight w is output as a result of the later-described classification processing. A default value of the weight may be set to any value. Also, the score function f is not particularly limited to a linier function, and may also be a nonlinear function.

The optimization unit 15d is a learning unit. In other words, the optimization unit 15d approximates, with respect to the AUC of a partial area of a ROC curve for a classifier that classifies data into a positive instance or a negative instance based on the calculated score, a nonlinear function portion of an object function using a predetermined method, the object function being represented by approximation of this pAUC, and learns the weight w so that the approximated object function is maximized.

Specifically, the optimization unit 15d determines the weight w so that the pAUC of a suitable partial area [α, β] on a ROC curve that is given by Formula (2) above is maximized.

Here, because the Heaviside step function I cannot be differentiated, the optimization unit 15d approximates the Heaviside step function I of Formula (2) using, for example, a logistic sigmoid function or the like, as shown in Formula (4).

[Formula 4]

σ(x⁺,x⁻;w)=[1+exp[−{f(x⁺)−f(x⁻)}]]^{31 1} (4)

In this case, the pAUC is given by Formula (5) below.

$$[ Formula 5 ]$$

$$pAUC = \frac{1}{mn ( β–α )} {\sum }_{i = 1}^{m} [ ( {j}_{α} - n α ) \cdot σ ( {x}_{i}^{+} , {x}_{( {j}_{α} )}^{-} ; w ) + {\sum }_{j = {j}_{α} + 1}^{{j}_{β}} ( {x}_{i}^{+} , {x}_{( j )}^{-} ; w ) + ( n β - {j}_{β} ) \cdot σ ( {x}_{i}^{+} , {x}_{( {j}_{β} + 1 )}^{-} ; w ) ] \qquad ( 5 )$$

The optimization unit 15d uses Formula (5), which is represented by approximation of the pAUC, as the object function, and performs optimization for maximizing the object function. Here, in the optimization of Formula (5), optimization calculation will be performed on a nonlinear function such as a logistic sigmoid function each time a negative instance is sorted in the order of scores, resulting in an increase in the calculation cost. Specifically, calculation of the multiplier of “exp” as shown in Formula (4) is required, and thus the amount of calculation in this case is denoted by O(e^{x}) using Landau notation, which is an order notation.

Accordingly, the optimization unit 15d approximates a nonlinear function portion of the object function using, for example, Pade approximation. Here, the Pade approximation is given by Formula (6) below.

$$[ Formula 6 ]$$

$$\begin{matrix}{e}^{- Ax} ≃ & \frac{1 - \frac{Ax}{2}}{1 + \frac{Ax}{2}} & \begin{matrix}First \text{-} order Pade \\ approximation \end{matrix} \\ ≃ & \frac{1 - \frac{Ax}{2} + \frac{{( Ax )}^{2}}{12}}{1 + \frac{Ax}{2} + \frac{{( Ax )}^{2}}{12}} & \begin{matrix}Second \text{-} order Pade \\ approximation \end{matrix} \\ ≃ & \frac{1 - \frac{Ax}{2} + \frac{{( Ax )}^{2}}{12} - \frac{{( Ax )}^{3}}{120}}{1 + \frac{Ax}{2} + \frac{{( Ax )}^{2}}{12} + \frac{{( Ax )}^{3}}{120}} & \begin{matrix}T hird \text{-} order Pade \\ approximation \end{matrix} \\ ≃ & \frac{1 - \frac{Ax}{2} + \frac{{( Ax )}^{2}}{12} - \frac{{( Ax )}^{3}}{48} + \frac{{( Ax )}^{4}}{384} - \frac{{( Ax )}^{5}}{3840}}{1 + \frac{Ax}{2} + \frac{{( Ax )}^{2}}{12} + \frac{{( Ax )}^{3}}{84} + \frac{{( Ax )}^{4}}{384} + \frac{{( Ax )}^{5}}{3840}} & \begin{matrix}F ourth \text{-} order Pade \\ approximation \end{matrix}\end{matrix} \qquad ( 6 )$$

Using, for example, the second-order Pade approximation, the optimization unit 15d applies Formula (7) below to Formula (5).

$$[ Formula 7 ]$$

$$σ ( {x}^{+} , {x}^{-} ; w ) = \frac{1}{2} ( 1 + \frac{6 \{ f ( {x}^{+} ) - f ( {x}^{-} ) \}}{12 + {\{ f ( {x}^{+} ) - f ( {x}^{-} ) \}}^{2}} ) \qquad ( 7 )$$

In this case, the amount of calculation that optimizes the object function approximated using the Pade approximation given by Formula (7) is denoted by O(x²) using the Landau notation. On the other hand, the amount of calculation that optimizes the object function given by Formula (5) is denoted by O(e^{x}) as described above. The amount of calculation of O(e^{x}) explosively increases with an increase in x. In contrast thereto, the amount of calculation of O(xⁿ) for an arbitrary constant n increases gradually, and thus the object function approximated using Formula (7) can suppress the calculation cost of the optimization unit 15d.

Note that the method for optimizing the object function is not particularly limited, and, for example, a stochastic gradient descent method, a Newton method, a quasi-Newton's method such as L-BFGS, a conjugate gradient method, or the like can be applied. Also, the objective function optimization problem can be rewritten. For example, maximizing the object function approximated using Formula (7), maximizing the logarithm of this object function, and minimizing the function of subtracting this object function from 1 have the same meaning.

Each time a negative instance is sorted in the order of scores as shown in “x₍ⱼ₎” in Formula (5), the optimization unit 15d performs processing for optimizing the object function approximated using Formula (7), and determines the weight w. That is to say, the optimization unit 15d determines the weight w so that the object function is maximized.

The weight w determined here is a result of calculation based on the score of the negative instance calculated using the weight in the previous step. Accordingly, the optimization unit 15d repeats the above-described processing for optimizing the object function until convergence is achieved.

For example, the optimization unit 15d determines that convergence has been achieved if the difference in the object function before the update (previous step) and after the update (current step) is smaller than or equal to a predetermined value. Alternatively, the optimization unit 15d may determine that convergence has been achieved if the difference in the weight w between before the update and after the update is smaller than or equal to a predetermined value. The optimization unit 15d stores the weight w when it is determined that convergence was achieved, as a solution of the pAUC optimization problem of maximizing the object function, in the parameter 14a of the storage unit 14.

Note that the method for approximating a nonlinear function portion of the object function is not limited to Pade approximation. For example, the optimization unit 15d may approximate the nonlinear function portion of the object function using Taylor expansion. The Taylor expansion (Maclaurin expansion) near 0 is given by Formula (8) below.

$$[ Formula 8 ]$$

$$\begin{matrix}{e}^{- Ax} ≅ & 1 + ( - Ax ) & First \text{-} order Maclaurin expansion \\ ≅ & 1 + ( - Ax ) + \frac{{( - Ax )}^{2}}{2 !} & S econd \text{-} order Maclaurin expansion \\ ≅ & 1 + ( - Ax ) + \frac{{( - Ax )}^{2}}{2 ′} + \frac{{( - Ax )}^{3}}{3 !} & T hird \text{-} order Maclaurin expansion \\ ≅ & 1 + ( - Ax ) + \frac{{( - Ax )}^{2}}{2 !} + \frac{{( - Ax )}^{3}}{3 !} + \frac{{( - Ax )}^{4}}{4 !} & F ourth \text{-} order Maclaurin expansion\end{matrix} \qquad ( 8 )$$

Similar to the case of Pade approximation, the amount of calculation when the nonlinear function portion of, for example, the logistic sigmoid function given by Formula (5) is approximated using the Taylor expansion given by Formula (8) is denoted, when Landau notation is used, in the same manner as in Pade approximation. Accordingly, by optimizing the object function given by Formula (5), it is possible to suppress the calculation cost of the optimization unit 15d.

Note that, because Pade approximation has smaller number of errors than that in the same order Taylor expansion, Pade approximation can perform accurate approximation with a smaller order relative to in Taylor expansion.

Similar to the learning data acquiring unit 15a, the test data acquiring unit 15e acquires test data to be subjected to later-described processing of the determination unit 15h, via the input unit 11 or the communication control unit 13. Note that the test data acquiring unit 15e may be the same functional unit as the learning data acquiring unit 15a.

Similar to the feature extracting unit 15b, the feature extracting unit 15f extracts the feature value of the test data, as preparation for the test data to be used in the later-described processing of the determination unit 15h, and converts the extracted feature value into a feature vector. The feature extracting unit 15f may be the same functional unit as the feature extracting unit 15b.

Similar to the score calculation unit 15c, the score calculation unit 15g calculates the score of the data based on the feature value of the data, using the score function f. Specifically, the score calculation unit 15g acquires the weight w determined with reference to the parameter 14a, and calculates the score of the feature value of the test data, using the score function f to which this weight w is applied. The score calculation unit 15g may be the same functional unit as the score calculation unit 15c.

The determination unit 15h determines whether the calculated score of the test data corresponds to a positive instance or a negative instance, using a predetermined threshold. For example, if the score is greater than or equal to the predetermined threshold, the determination unit 15h determines that it corresponds to a positive instance, and if the score is less than the predetermined threshold, the determination unit 15h determines that it corresponds to a negative instance. Therefore, the determination unit 15h classifies the test data into any one of the positive instance and the negative instance. Also, the determination unit 15h outputs the determination result of the test data to the output unit 12.

[Classification Processing]

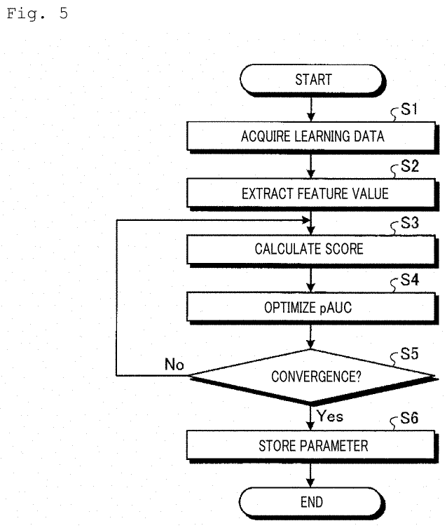

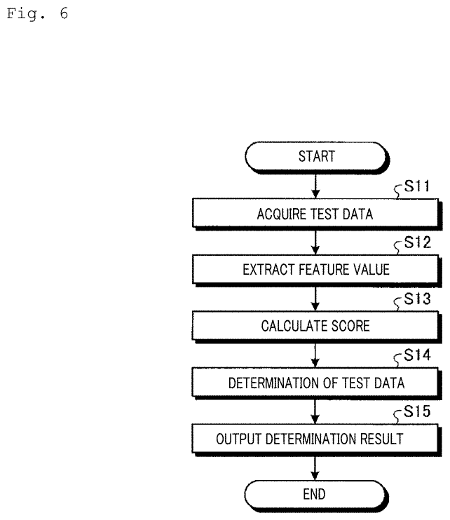

The following will describe classification processing performed by the classification apparatus 10 according to the present embodiment with reference to FIGS. 5 and 6. The classification processing includes learning processing and determination processing. FIG. 5 is a flowchart showing a procedure of the learning processing. The flowchart of FIG. 5 starts at a timing at which, for example, a user inputs an operation for giving an instruction to start the learning processing.

First, the learning data acquiring unit 15a accepts, via the input unit 11 or the communication control unit 13, an input of learning data (step S1). Then, the feature extracting unit 15b extracts the feature value of the input learning data (step S2), and converts the extracted feature value into a feature vector.

Also, the score calculation unit 15c calculates, based on the feature vector of the learning data and a weight w, the score of the learning data using the score function f (step S3). At this time, the score calculation unit 15c applies the weight determined in the previous step as the weight w.

Then, the optimization unit 15d uses the calculated score to perform optimization processing for learning the weight w that maximizes the pAUC given by Formula (2) above (step S4). Specifically, the optimization unit 15d uses, as an object function, a formula obtained by approximating, using e.g., Pade approximation of Formula (7), a nonlinear function portion of a formula, as given by Formula (5), represented by approximation of the pAUC of Formula (2), and learns the weight w so that this object function is maximized.

Also, the optimization unit 15d performs convergence determination (step S5). For example, the optimization unit 15d determines that convergence has been achieved if the difference in the object function between before the update (previous step) and after the update (current step) is smaller than or equal to a predetermined value. Alternatively, the optimization unit 15d may determine that convergence has been achieved if the difference in the weight w between before the update and after the update is smaller than or equal to a predetermined value.

If it is determined that convergence has not been achieved (No in step S5), the optimization unit 15d returns the procedure to step S3.

On the other hand, if it is determined that convergence has been achieved (Yes in step S5), the optimization unit 15d stores the determined weight w in the parameter 14a of the storage unit 14, as a classifier parameter that maximizes the pAUC (step S6). Accordingly, the series of learning processing are ended.

FIG. 6 is a flowchart showing a procedure of the determination processing. The flowchart of FIG. 6 starts at a timing at which, for example, a user inputs an operation for giving an instruction to start determination processing.

First, the test data acquiring unit 15e accepts, via the input unit 11 or the communication control unit 13, an input of test data to be processed (step S11). Then, the feature extracting unit 15f extracts the feature value of the test data (step S12), and converts the extracted feature value into a feature vector.

Also, the score calculation unit 15g calculates, based on the feature vector of the test data, the score of the data using the score function f (step S13). At this time, the score calculation unit 15g acquires the weight w determined with reference to the parameter 14a, and calculates the score of the test data, using the score function f to which this weight w is applied.

Then, the determination unit 15h determines, using a predetermined threshold, whether the calculated score of the test data corresponds to a positive instance or a negative instance (step S14). For example, if the score is greater than or equal to the predetermined threshold, the determination unit 15h determines that it corresponds to a positive instance, and if the score is less than the predetermined threshold, the determination unit 15h determines that it corresponds to a negative instance. Accordingly, the determination unit 15h classifies the test data into any one of the positive instance and the negative instance.

Also, the determination unit 15h outputs the determination result of the test data to the output unit 12 (step S15). Accordingly, the series of determination processing are ended.

As described above, in the classification apparatus 10 according to the present embodiment, the score calculation unit 15c calculates, based on the feature value of the data and the weight, the score of the data using the score function f. Also, the optimization unit 15d approximates, with respect to an AUC of a partial area of a ROC curve for a classifier that classifies the data into a positive instance or a negative instance based on the calculated score, a nonlinear function portion of an object function using a predetermined method, the object function being represented by approximation of the pAUC, and learns the weight w so that the object function is maximized. For example, the optimization unit 15d approximates a nonlinear function portion of the object function using Taylor expansion, Pade approximation, or the like.

Accordingly, the classification apparatus 10 of the present embodiment can significantly suppress the amount of calculation of the nonlinear function portion in processing for optimizing the object function that is repeated each time a negative instance is sorted in the order of scores. With this, according to the classification apparatus 10 of the present embodiment, it is possible to optimize a portion of the AUC of the binary classification problem while suppressing the calculation cost.

Specifically, when the optimization unit 15d approximates the nonlinear function portion of the object function using Pade approximation, the approximation will be performed more accurately than in a case where Taylor expansion is used for approximation, and thus it is possible to perform accurate approximation with a smaller order relative to in the case of Taylor expansion. Accordingly, the classification apparatus 10 can optimize the pAUC while maintaining the accuracy.

Also, the optimization unit 15d further determines that convergence has been achieved, if the difference between the previous maximized object function and the current maximized object function is smaller than or equal to a predetermined value. Also, the optimization unit 15d further determines that convergence has been achieved, if the difference between the weight corresponding to the previous maximized object function and the weight corresponding to the current maximized object function is smaller than or equal to a predetermined value. Accordingly, the classification apparatus 10 can optimize the pAUC more effectively.

[Program]

It is also possible to generate a program in which processing to be executed by the classification apparatus 10 according to the foregoing embodiment is described in a language that a computer can execute. As an embodiment, the classification apparatus 10 can be implemented by installing, in a desired computer, a classification program for executing the classification processing as package software or online software. For example, by causing an information processing apparatus to execute the above-described classification program, the information processing apparatus can function as the classification apparatus 10. In this context, the information processing apparatus includes a desktop personal computer and a notebook personal computer. Also, in addition thereto, the category of the information processing apparatus includes a mobile communication terminal such as a smartphone, a mobile phone, and a Personal Handyphone System (PHS), a slate terminal such as a Personal Digital Assistant (PDA), and the like. Also, the functions of the classification apparatus 10 may also be implemented in a cloud server.

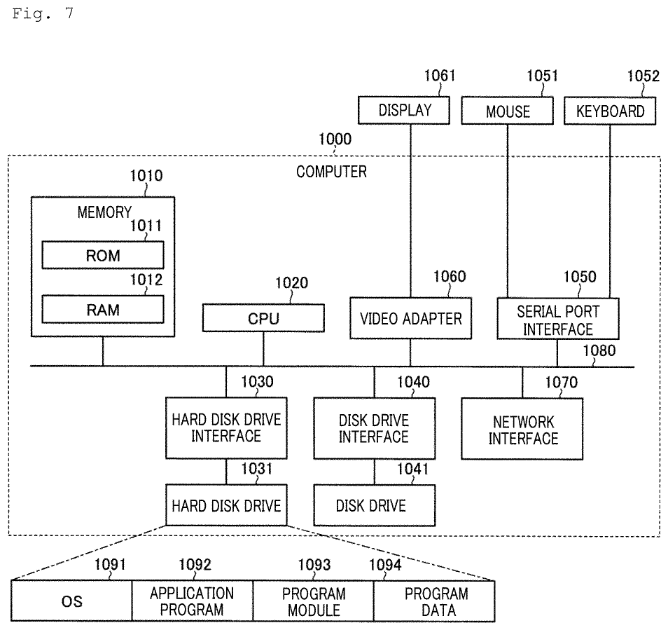

FIG. 7 is a diagram illustrating an example of a computer that executes the classification program. A computer 1000 includes, for example, a memory 1010, a CPU 1020, a hard disk drive interface 1030, a disk drive interface 1040, a serial port interface 1050, a video adapter 1060, and a network interface 1070. These units are connected to each other via a bus 1080.

The memory 1010 includes a Read Only Memory (ROM) 1011 and a RAM 1012. The ROM 1011 stores, for example, a boot program such as a Basic Input Output System (BIOS). The hard disk drive interface 1030 is connected to a hard disk drive 1031. The disk drive interface 1040 is connected to a disk drive 1041. A detachable storage medium such as, for example, a magnetic disk or an optical disc is inserted into the disk drive 1041. For example, a mouse 1051 and a keyboard 1052 is connected to the serial port interface 1050. For example, a display 1061 is connected to the video adapter 1060.

Here, the hard disk drive 1031 stores, for example, an OS 1091, an application program 1092, a program module 1093, and program data 1094. Various types of information described in the foregoing embodiment are stored in the hard disk drive 1031 or the memory 1010, for example.

Also, the classification program is stored as, for example, the program module 1093 in which commands to be executed by the computer 1000 are described, in the hard disk drive 1031. Specifically, the program module 1093 in which the pieces of processing that have been described in the foregoing embodiment and are to be executed by the classification apparatus 10 are described is stored in the hard disk drive 1031.

Furthermore, data to be used for information processing that is performed using the classification program is stored as the program data 1094 in, for example, the hard disk drive 1031. Also, the CPU 1020 reads the program module 1093 and the program data 1094 stored in the hard disk drive 1031 onto the RAM 1012 as needed, and executes the above-described procedures.

Note that the program module 1093 and the program data 1094 according to the classification program are not limited to being stored in the hard disk drive 1031, and may also be stored in a detachable storage medium for example, and may be read by the CPU 1020 via the disk drive 1041 or the like. Alternatively, the program module 1093 and the program data 1094 according to the classification program may also be stored in another computer connected thereto via a network such as the Local Area Network (LAN) or the Wide Area Network (WAN), and may be read by the CPU 1020 via the network interface 1070.

The embodiment to which the present invention made by the applicants was applied has been described, but the present invention is not limited by the description and the drawings of the present embodiment, which constitute part of the disclosure of the present invention. In other words, all of other embodiments, working examples, operation techniques, and the like that are implemented by a person skilled in the art based on the present embodiment are included in the scope of the present invention.

### REFERENCE SIGNS LIST

10 Classification apparatus
11 Input unit
12 Output unit
13 Communication control unit
14 Storage unit
14a Parameter
Control unit
15a Learning data acquiring unit
15b Feature extracting unit
15c Score calculation unit
15d Optimization unit (learning unit)
15e Test data acquiring unit
15f Feature extracting unit
15g Score calculation unit
15h Determination unit

1. A classification apparatus, comprising:
score calculation circuitry configured to calculate, based on a feature value of data and a weight, a score of the data using a score function; and
learning circuitry configured to approximate, with respect to an AUC of a partial area of a ROC curve for a classifier that classifies the data into a positive instance or a negative instance based on the calculated score, a nonlinear function portion of an object function using a predetermined method, the object function being represented by approximation of the AUC, and learn the weight so that the approximated object function is maximized.

2. The classification apparatus according to claim 1, wherein:
the learning circuitry approximates the nonlinear function portion of the object function using Pade approximation.

3. The classification apparatus according to claim 1, wherein:
the learning circuitry approximates the nonlinear function portion of the object function using Taylor expansion.

4. The classification apparatus according to claim 1, wherein the learning circuitry further determines that convergence has been achieved, if a difference between a previous maximized object function and the current maximized object function is smaller than or equal to a predetermined value.

5. The classification apparatus according to claim 1, wherein the learning circuitry further determines that convergence has been achieved, if a difference between a weight that corresponds to a previous maximized object function and the weight that corresponds to the current maximized object function is smaller than or equal to a predetermined value.

6. A classification method that is executed by a classification apparatus, comprising:
a score calculation step of calculating, based on a feature value of data and a weight, a score of the data using a score function; and
a learning step of approximating, with respect to an AUC of a partial area of a ROC curve for a classifier that classifies the data into a positive instance or a negative instance based on the calculated score, a nonlinear function portion of an object function using a predetermined method, the object function being represented by approximation of the AUC, and learning the weight so that the approximated object function is maximized.

7. A non-transitory computer readable medium which stores a classification program for causing a computer to execute a method comprising:
a score calculation step of calculating, based on a feature value of data and a weight, a score of the data using a score function; and
a learning step of approximating, with respect to an AUC of a partial area of a ROC curve for a classifier that classifies the data into a positive instance or a negative instance based on the calculated score, a nonlinear function portion of an object function using a predetermined method, the object function being represented by approximation of the AUC, and learning the weight so that the approximated object function is maximized.
